(19) United States
(12) Patent Application Publication
(10) Pub. No.: US 2026/0350687 A1
(43) Pub. Date: Nov. 5, 2026

(54) TRIP PREDICTION SYSTEM

(71) Applicant: Booking.com B.V., Amsterdam (NL)

(72) Inventor: Pranav Pathak, Amsterdam (NL)

(21) Appl. No.: 19/656,221

(22) Filed: Apr. 23, 2026

Related U.S. Application Data
(60) Provisional application No. 63/797,454, filed on Apr. 30, 2025.

(51) Int. Cl. G06Q 30/0601; G06Q 30/0282; G06Q 50/14

(52) U.S. Cl. CPC G06Q 30/0631; G06Q 30/0282; G06Q 50/14

(57) ABSTRACT

A computer-implemented method comprising reading travel booking items associated with a particular user account in a database; grouping the travel booking items specifying one or more common attributes into a digitally stored draft travel itinerary; programmatically calling a large language model (LLM) application programming interface (API) with a first prompt to determine a user intent that the booking items of the travel itinerary collectively represent and receiving a first LLM response specifying the user intent; calling a recommendations pipeline to generate initial additional travel items for the travel itinerary based on location features, trip features, and the user intent of the first LLM response; accessing context data for the particular user account and one or more implicit signals from past booking or preference data and explicit signals represented in the booking items; receiving user input expressing one or more location features, trip features, or other user intent associated with a prospective trip; programmatically calling the LLM API with a second prompt, including the context data and the initial travel items, receiving a second LLM response, and forming a digitally stored updated travel itinerary; generating and causing displaying a digital electronic document showing travel items of the second LLM response with positive feedback controls and negative feedback controls; receiving one or more feedback signals via the positive feedback controls or the negative feedback controls and, in response, updating a satisfaction score associated with the particular user account and the updated travel itinerary; determining if a travel item is dismissed based on the one or more feedback signals and updating the context data if a travel item was dismissed; determining if the satisfaction score is below a threshold value generating a user query if the satisfaction score is below the threshold value; and transmitting the user query via a chat interface or other output channel.

### BENEFIT CLAIM

This application claims the benefit of provisional application 63/797,454, filed Apr. 30, 2025, the entire contents of which is hereby incorporated by reference for all purposes as if fully set forth herein.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright or rights whatsoever. © 2024-2025 Booking.com B.V.

### TECHNICAL FIELD

One technical field of the present disclosure relates to artificial intelligence and machine learning. Another technical field is graphical user interfaces useful in travel booking and recommendations

### BACKGROUND

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

Travel planning is an inexact science for most consumers, often involving guesses about whether a particular accommodation, activity, or other element will be satisfactory given the consumer's goals or desires. Consumers commonly book multiple travel elements with only a generalized sense of a trip itinerary and with minimal knowledge about whether the elements will be satisfactory individually or in combination, and without focusing on potential gaps in plans.

Artificial intelligence-based travel planning systems have recently developed the capability to identify travel elements and to automatically generate a complete travel itinerary.

Based on the foregoing, purveyors of travel planning services, booking services, and other travel-related services have developed an acute need to provide improved computer-supported travel planning services that increase trip satisfaction.

### SUMMARY

The appended claims may serve as a summary of the invention.

### BRIEF DESCRIPTION OF THE DRAWINGS

In the drawings:

FIG. 1 illustrates a distributed computer system showing the context of use and principal functional elements with which one embodiment could be implemented.

FIG. 2 illustrates an example of a generative artificial intelligence (AI) reservation management and orchestration system.

FIG. 3A illustrates an example of a generative AI orchestration system.

FIG. 3B illustrates a natural language processing (NLP) service system.

FIG. 4 illustrates an example recommendation system and pipeline(s).

FIG. 5A illustrates a view of the system of FIG. 4 with additional trip prediction logic in one embodiment.

FIG. 5B illustrates an example processing flow that the trip prediction instructions are programmed to execute in one embodiment.

FIG. 6A illustrates a set of example travel booking items of one embodiment.

FIG. 6B, FIG. 6C, FIG. 6D, and FIG. 6E collectively illustrate the first through fourth portions of a scrollable electronic document or web page of one embodiment.

FIG. 7 illustrates a computer system with which one embodiment could be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

The text of this disclosure, in combination with the drawing figures, is intended to state in prose the algorithms that are necessary to program a computer to implement the claimed inventions at the same level of detail that is used by people of skill in the arts to which this disclosure pertains to communicate with one another concerning functions to be programmed, inputs, transformations, outputs and other aspects of programming. That is, the level of detail set forth in this disclosure is the same level of detail that persons of skill in the art normally use to communicate with one another to express algorithms to be programmed or the structure and function of programs to implement the inventions claimed herein.

Embodiments are described in the sections below according to the following outline:
1. General Overview
2. Structural & Functional Overview
3. Implementation Example—Hardware Overview

### 1. General Overview

Various embodiments encompass the subject matter of the following numbered clauses:
1. A computer-implemented method comprising reading travel booking items associated with a particular user account in a database; grouping the travel booking items specifying one or more common attributes into a digitally stored draft travel itinerary; programmatically calling a large language model (LLM) API with a first prompt to determine a user intent that the booking items of the travel itinerary collectively represent and receiving a first LLM response specifying the user intent; calling a recommendations pipeline to generate initial additional travel items for the travel itinerary based on location features, trip features, and the user intent of the first LLM response; accessing context data for the particular user account and one or more implicit signals from past booking or preference data and explicit signals represented in the booking items; receiving user input expressing one or more location features, trip features, or other user intent associated with a prospective trip; programmatically calling the LLM API with a second prompt, including the context data and the initial travel items, receiving a second LLM response, and forming a digitally stored updated travel itinerary; generating and causing displaying a digital electronic document showing travel items of the second LLM response with positive feedback controls and negative feedback controls; receiving one or more feedback signals via the positive feedback controls or the negative feedback controls and, in response, updating a satisfaction score associated with the particular user account and the updated travel itinerary; determining if a travel item is dismissed based on the one or more feedback signals and updating the context data if a travel item was dismissed; determining if the satisfaction score is below a threshold value generating a user query if the satisfaction score is below the threshold value; and transmitting the user query via a chat interface or other output channel.
2. The method of clause 1, wherein reading travel booking items associated with a particular user in the database further comprises accessing two or more relational database tables storing historical booking data and user preferences.
3. The method of clause 1, wherein grouping the booking items into a draft travel itinerary further comprises identifying travel booking items that share common attributes such as travel dates, destinations, and number of travelers.
4. The method of clause 1, wherein programmatically calling the LLM API with the first prompt to determine the user intent further comprises generating a natural language prompt that encapsulates the travel booking items and the context data.
5. The method of clause 1, further comprising receiving, from the recommendations pipeline, the initial travel items by the recommendations pipeline programmatically analyzing one or more points of interest, local events, or weather conditions.
6. The method of clause 1, wherein the context data accessed includes user preferences derived from social media activity, previous travel reviews, and interaction history with a travel service provider.
7. The method of clause 1, wherein the user input received includes specific preferences for accommodation types, transportation modes, and activity interests.
8. The method of clause 1, wherein the digital electronic document comprises one or more user interface widgets which, when selected, modify or approve one or more travel items of the updated travel itinerary.
9. The method of clause 1, wherein the one or more feedback signals received include user interactions such as clicks, likes, dislikes, and comments on the one or more travel items.
10. The method of clause 1, further comprising calculating the satisfaction score based on a weighted combination of positive and negative feedback signals.
11. The method of clause 1, wherein the user query includes suggestions for alternative travel items or requests for additional information based on the one or more feedback signals.
12. The method of clause 1, wherein the chat interface used to transmit the user query supports natural language processing to facilitate user interaction and response.
13. A system for generating travel itinerary recommendations comprising a reservation management system configured to read booking items associated with a user; a large language model (LLM) API configured to determine user intent based on the booking items; a recommendations pipeline configured to generate initial travel items based on location features, trip features, and user intent; a context data module configured to access user context data including travel party size, preferences, and budget history; a user input module configured to receive user input expressing location features, trip features, or other user intent; a display module configured to generate and display travel items with feedback controls; a feedback module configured to receive feedback signals and update a satisfaction score; a query generation module configured to generate user queries if the satisfaction score is below a threshold; and a communication interface configured to transmit user queries via a chat interface.
14. The system of clause 13, wherein the reservation management system is further configured to access a database storing historical booking data and user preferences.
15. The system of clause 13, wherein the LLM API is configured to generate natural language prompts that encapsulate booking items and context data.
16. The system of clause 13, wherein the recommendations pipeline analyzes location features such as points of interest, local events, and weather conditions to generate initial travel items.
17. The system of clause 13, wherein the context data module accesses user preferences derived from social media activity, previous travel reviews, and interaction history with a travel service provider.
18. The system of clause 13, wherein the user input module receives specific preferences for accommodation types, transportation modes, and activity interests.
19. The system of clause 13, wherein the display module provides one or more user interface widgets which, when selected, modify or approve suggested travel items.
20. The system of clause 13, wherein the feedback module calculates the satisfaction score based on a weighted combination of positive and negative feedback signals.

### 2. Structural & Functional Overview

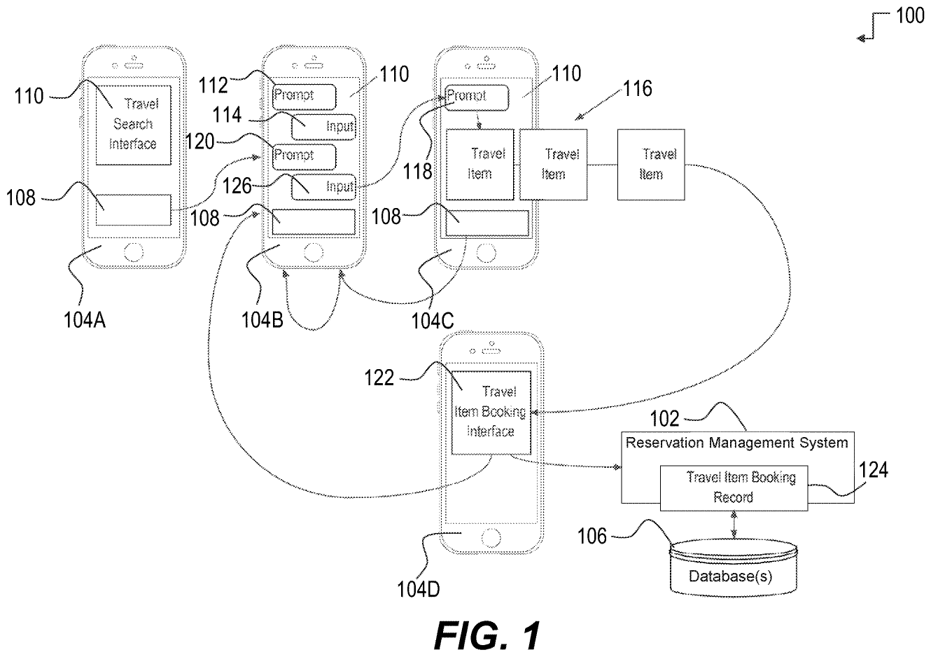

FIG. 1 illustrates a distributed computer system showing the context of use and principal functional elements with which one embodiment could be implemented. In an embodiment, a computing environment 100 includes a reservation management system 102 and one or more mobile computing devices 104A-104D, which may each include components implemented partially by hardware, such as one or more hardware processors executing stored program instructions stored in one or more databases 106 for performing the functions described herein. In other words, all functions described herein are intended to indicate operations performed using programming in a special or general-purpose computer in various embodiments. FIG. 1 illustrates only one of many possible arrangements of components configured to execute the programming described herein. Other arrangements may include fewer or different components, and the division of work between the components may vary depending on the arrangement.

FIG. 1, and the other drawing figures and all of the description and claims in this disclosure, are intended to present, disclose, and claim a technical system and technical methods in which specially programmed computers, using a special-purpose distributed computer system design, execute functions that have not been available before to provide a practical application of computing technology to the problem of identifying, generating, and providing travel itinerary recommendations in response to natural language requests. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

In one embodiment, by identifying, generating, and providing travel itinerary recommendations in response to natural language requests, compute-intensive database queries and server network traffic may be markedly reduced, namely due to the server and database not having to respond to an otherwise large number of superfluous search queries or providing cold-start recommendations as associated with existing reservation management systems. Moreover, by identifying, generating, and providing travel itinerary recommendations in response to natural language requests, overall CPU or GPU performance in execution time, latency, power consumption, and clock speed may all be markedly improved.

In certain embodiments, a computing environment 100 may include a reservation management system 102 and one or more mobile computing devices 104A-104D. For example, in certain embodiments, the reservation management system 102 may include a cloud-based computing architecture suitable for identifying, generating, and providing travel itinerary recommendations in response to natural language requests in an embodiment. For example, in one embodiment, the reservation management system 102 may include a Platform as a Service (PaaS) architecture, a Software as a Service (SaaS) architecture, an Infrastructure as a Service (IaaS) architecture, a Compute as a Service (CaaS) architecture, a Data as a Service (DaaS) architecture, a Database as a Service (DBaaS) architecture, or other similar cloud-based computing architecture.

The reservation management system 102 may include one or more processors, such as a general-purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), a deep learning processor (DLP), a tensor processing unit (TPU), a neuromorphic processing unit (NPU), or any other artificial intelligence (AI) accelerator device(s) that may be suitable for processing various travel, lodging, and logistics data and making one or more predictions or decisions based thereon.

In certain embodiments, one or more mobile computing devices 104A-104D may include any devices suitable for allowing users to launch and engage with a reservation management application executing on one or more mobile computing devices 104A-104D. For example, the reservation management application executing on one or more mobile computing devices 104A-104D may be serviced and hosted by the reservation management system 102, which may be coupled to one or more mobile computing devices 104 via a communication network(s), for example. In certain embodiments, the database 106 may include, for example, one or more relational databases or data lakes that may be utilized to store real-time and historical information to be accessed and utilized by the reservation management system 102. Examples of real-time and historical information include travel data, lodging data, logistics data, transport data, map data, destination data, user profile data, user behavioral data, reservation history data, attractions data, and contextual data.

In certain embodiments, as depicted by the mobile computing device 104A, reservation management system 102 may cause the mobile computing device 104A to display a chat interface 110 within the reservation application executing on the mobile computing device 104A. For example, referring to the mobile computing device 104B, the reservation management system 102 may cause the chat interface 110 within the reservation application executing on the mobile computing device 104B to display a prompt 112, which may be utilized to prompt a user of the mobile computing device 104B to input a request via a chat message input bar 108. In certain embodiments, in response to prompt 112, the user may input into the chat message input bar 108 a chat message 114 corresponding to a request.

In one embodiment, the chat message 114 may be programmatically classified by the reservation management system 102 to identify an intent and a named entity for the chat message 114 to satisfy the request. For example, in one embodiment, the chat message 114 may include a request with sufficient contextual information for the reservation management system 102 to identify a user intent and a named entity for the chat message 114, such as “I would like to visit a Caribbean beach this summer.” In another embodiment, the chat message 114 may include a request with insufficient contextual information for the reservation management system 102 to identify the intent and a named entity for the chat message 114, such as “I would like to reserve a trip for this summer.” In this context, and any of the embodiments of the disclosure, contextual information can comprise any one or more digitally stored data items from among chat history, filters, data relating to past trips or system interactions, including travel history and preferences, in-session data, including the specific filters selected for a search such as pool, beach proximity, or ski lift, and any themes selected for prospective travel, such as beach holiday or Italian food. The use of any such data items can occur only if the end-user previously gives input specifying consent for the system to use that data.

Different embodiments can be programmed to identify sufficient contextual information using different rules, heuristics, thresholds, or logical requirements. In one embodiment, determining whether enough contextual information is provided to ascertain user intent and/or whether enough search terms have been accumulated from the conversation is threshold-based and programmed to inspect the number of required words, descriptors, features, or tokens in a conversation. In one embodiment, sufficient contextual information is logically present when a chat conversation has specified the number of travelers, an approximate destination, and approximate travel dates. In other embodiment, sufficient contextual information is logically present when a chat conversation has specified at least one value for Traveler Group, Location Context, Time Context, and Trip Vibes/Themes. Furthermore, in one embodiment, if the chat conversation lacks an express intent concerning user location, known user location data can contribute to the execution of the recommendation pipeline. For example, with prior user consent, data from a mobile device, browser, or other source associated with the user and specifying the user's current location can be passively considered. Such location data can be used to return personalized recommendations based on location, with queries such as: “Show me attractions nearby” or “Show me warm destinations with a beach within 4 hours flights from me.”

Other embodiments can modify these requirements based on other known user contextual information and the needs of a particular functional element of the system. For example, the foregoing information is unnecessary to answer specific questions about a chosen property. Depending on how these requirements are programmed, user chat conversations can involve two to five or more turns or rounds before presenting specific recommended travel items.

In certain embodiments, based on whether the reservation management system 102 may identify an intent and a named entity for the chat message 114, the reservation management system 102 may cause the chat interface 110, within the reservation application executing on the mobile computing device 104B, to display a prompt chat message 120, which may be utilized to prompt a user of the mobile computing device 104B to input a chat message 126 for providing additional contextual information. Otherwise, as further depicted by the mobile computing device 104C, the reservation management system 102 may generate and output travel items 116 and a chat message 118, which may include one or more descriptors of the identified intent and named entity for the chat message 114.

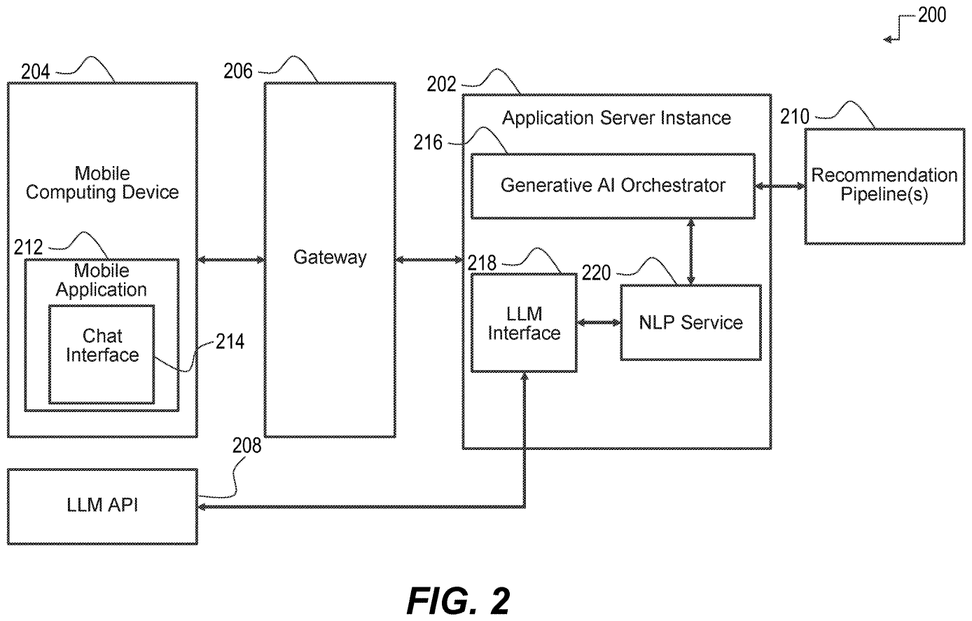

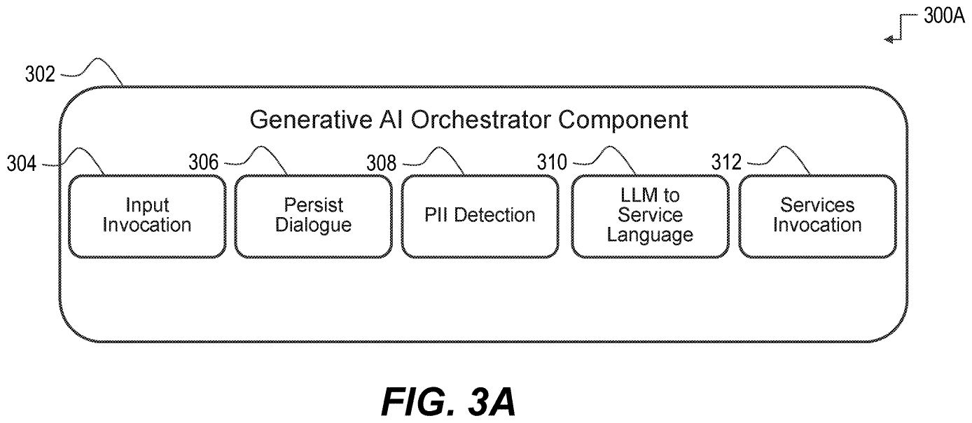

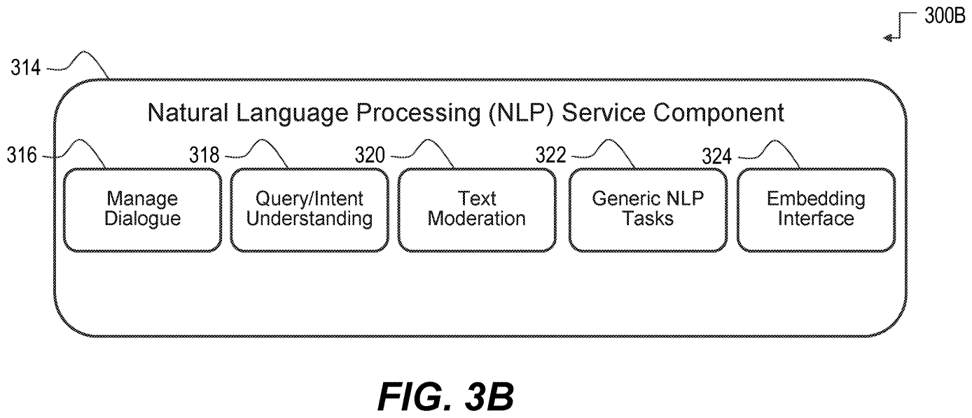

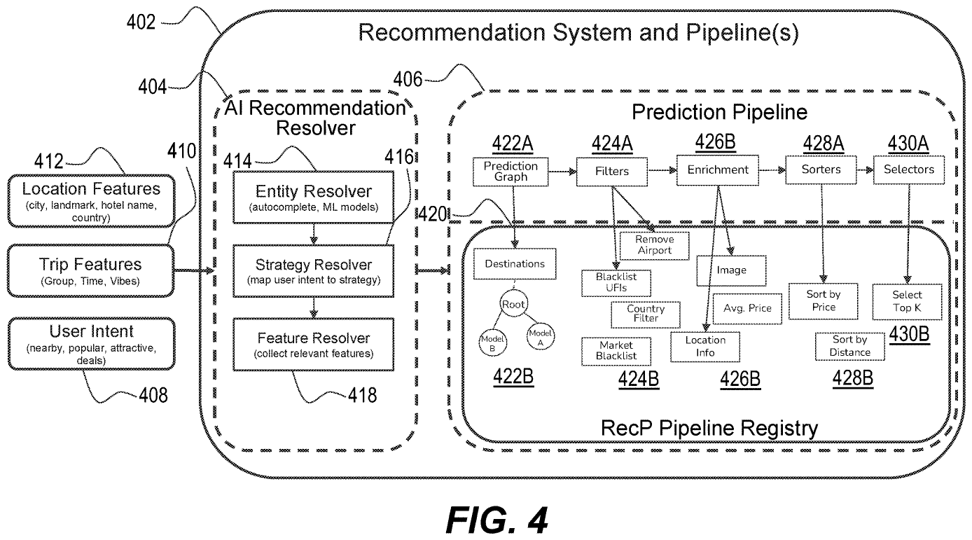

For example, in one embodiment, the number of travel items 116 may include several recommendations of one or more travel destinations and/or one or more recommendations of lodgings or transport. For example, the destination could be a Caribbean beach destination, the lodging recommendation could be a hotel on a Caribbean island, and the transport recommendations could specify flights to the Caribbean region. As will be further appreciated below concerning FIG. 2, FIG. 3A, FIG. 3B, and FIG. 4, for example, the reservation management system 102 may retrieve the number of recommendations of one or more travel destinations and/or one or more recommendations of lodgings or transports from a recommendation system suitable for generating the number of recommendations of one or more travel destinations and/or one or more of recommendations of lodgings or transports.

In certain embodiments, as depicted by the mobile computing device 104D, the number of travel items 116 may each include a GUI widget that may be programmed when selected to initiate a reservation dialog interface 122 based on the selected travel item. For example, when the user selects a travel item corresponding to “Caribbean beach lodging #1,” a GUI widget that may initiate a reservation dialog interface 122 within the reservation application executing on the mobile computing device 104D, thus allowing the user to instantiate a travel item booking record 124 or reservation with “Caribbean beach lodging #1,” for example.

The chat conversation system can be programmed using technical measures or programming techniques to reduce maximum latency in responding to a user prompt. Examples include making the LLM prompt flow asynchronous and splitting the JSON extraction prompts to multiple prompts.

### 2.2 Generative Artificial Intelligence Orchestration System

FIG. 2 illustrates an example of a generative artificial intelligence (AI) reservation management and orchestration system. In an embodiment, the generative AI reservation management and orchestration system 200 may include an application server 202, a mobile computing device 204, a gateway 206, a large language model (LLM) application programming interface (API) 208, and a recommendation system and pipeline(s) 210. In certain embodiments, the mobile computing device 204 may include any computing device suitable for allowing a user to launch and engage with a reservation management application 212 executing on the device 204. In various embodiments, the mobile computing device could be a smartphone, laptop computer, desktop computer, tablet computer, or wearable electronic device. In one embodiment, reservation management application 212 may be a mobile application that can be accessed on a personal electronic device corresponding to a mobile computing device 204. In another embodiment, reservation management application 212 may be a web application that can be accessed via a web browser of a desktop electronic device such as a desktop computer or laptop computer, such as mobile computing device 204.

In certain embodiments, as described below, the reservation management application 212 executing on the mobile computing device 204 may be serviced and hosted by the application server 202. For example, in certain embodiments, the application server 202 may include any AI chatbot application architecture or AI natural language conversational application architecture suitable for identifying, generating, and providing travel itinerary recommendations in response to one or more chat message requests provided by the user via a chat interface 214. The chat interface 214 can comprise a message interface including a message bar and user interface keyboard. For example, in certain embodiments, at runtime, a user may input via chat interface 214 a natural language text sequence corresponding to a request for a reservation of a travel itinerary. In certain embodiments, reservation management application 212, executed on mobile computing device 204, is programmed to provide input in a natural language text sequence corresponding to the user's request for a reservation of a travel itinerary to gateway 206.

In certain embodiments, the gateway 206 may include any hardware system, software system, or some combination of a hardware and software system suitable for pre-processing the input natural language text sequence and routing the input natural language text sequence to the application server 202. As previously noted, in certain embodiments, the application server 202 may include any AI chatbot application architecture or AI natural language conversational application architecture suitable for identifying input natural language text sequence, generating natural language responses to it, and retrieving and providing travel itinerary recommendations corresponding to an identified intent and one or more named entities associated with the input natural language text sequence corresponding to the user's request for a reservation of a travel itinerary.

For example, as further depicted by the generative AI reservation management and orchestration system 200, the application server 202 may include a generative AI orchestrator 216, an LLM interface 218, and a natural language processing (NLP) service component 220. For example, as will be discussed in greater detail below concerning FIG. 3A, the generative AI orchestrator 216 may include an orchestration engine, an intelligent API, or other similar system manager suitable for facilitating user input natural language text sequences and orchestrating services, such as the LLM interface 218, the NLP service component 220, the LLM API 208 and associated external LLM, and the recommendation system and pipeline(s) 210 to understand and identify user intent and to generate a response to the user by way of the reservation management application 212 executing on the mobile computing device 204.

Specifically, as will be discussed in greater detail below concerning FIG. 3B and others, the NLP service component 220 may include machine-learning model-based service utilized for performing linguistic tasks, such as sentiment analysis, information retrieval, information extraction, text summarization, question-answering, tokenization, parts-of-speech tagging, parsing, and so forth that may be associated with providing contextual responses to user input natural language text sequences provided to the application server 202. Similarly, the recommendation system and pipeline(s) 210 may include one or more machine-learning model-based platforms suitable for surfacing and providing recommendations of one or more travel itineraries, such as travel destinations or attractions, accommodations, or means of transport, in a uniquely personalized manner and corresponding to an identified intent and one or more named entities associated with the input natural language text sequence corresponding to the user's request for a reservation of a travel itinerary. In this context, travel destinations can include a country, a city, a province, a region, an island or islet, a campsite, and so forth. Accommodations could include a hotel, a cabin, a hostel, a home-sharing space, and so forth. Means of transport could be a flight reservation, a rental car reservation, a train reservation, a recreational vehicle (RV) reservation, and so forth.

In certain embodiments, upon determining whether an intent and one or more named entities associated with the input natural language text sequence corresponding to the user's request for a reservation of a travel itinerary can be identified, the LLM interface 218 may provide a prompt corresponding to the user's request for a reservation of a travel itinerary to the LLM API 208 and an associated external LLM to generate a context responsive to the input natural language text sequence corresponding to the user's request for a reservation of a travel itinerary. In various embodiments, the LLM API 208 may be associated with generative pre-trained Transformer models like GPT-3.5, GPT-4.0, GPT-4.5, and successor models, other public or networked LLMs, or internal, on-prem, or hosted LLMs.

In one embodiment, the generated response may include a natural language text sequence, including one or more descriptors of an identified input natural language text sequence corresponding to the user's request for a reservation of a travel itinerary. In another embodiment, the generated response may include a natural language text sequence, including a request for additional context information associated with the user's request for a reservation of a travel itinerary.

In certain embodiments, the response generated by the LLM is received at the LLM interface 218 via the LLM API 208. The LLM interface 218 may provide the generated response to gateway 206. In certain embodiments, the gateway 206 is programmed to perform a post-processing of the generated response and route the generated response to the reservation management application 212, which is executed on the mobile computing device 204 and presented to the user by way of the chat interface 214.

### 2.3 Generative Artificial Intelligence Orchestrator

FIG. 3A illustrates an example of a generative AI orchestration system. As depicted, the generative AI orchestration system 300 may include a generative AI orchestrator component 302. In one embodiment, the generative AI orchestrator component 302 may be identical to the generative AI orchestrator 216, as discussed above with respect to FIG. 2. Thus, as generally discussed above, the generative AI orchestrator component 302 may include an orchestration engine, an intelligent API, or other similar system manager suitable for facilitating user input natural language text sequences received from the gateway 206 and orchestrating different underlying services to generate a contextual response.

As depicted by FIG. 3A, in certain embodiments, the generative AI orchestrator component 302 may include an input invocation component 304, a persist dialogue component 306, a personal identification information (PII) detection component 308, an LLM to service language component 310, and a services invocation component 312. For example, in certain embodiments, the input invocation component 304 may include a software service suitable for programmatically calling or invoking, for example, the LLM API 208 and an associated LLM. In certain embodiments, the persist dialogue component 306 may include a software service suitable for storing user input natural language text sequences corresponding to a user's request for a reservation of a travel itinerary and the generated responses, as well as managing the dialogue flow between the user and the external LLM.

In certain embodiments, the PII detection component 308 may include a software service suitable for detecting whenever a user input natural language text sequence does not correspond to a request for a reservation of a travel itinerary or otherwise includes obscene language, hate speech, or other objectional language or text. Similarly, in certain embodiments, the LLM to service language component 310 may include a software service suitable for translating the user input natural language text sequence into a form more understandable or consumable, for example, by the NLP service component 220 and/or the LLM API 208 and an associated external LLM. For example, in one embodiment, the LLM to service language component 310 may be utilized to tokenize the user input natural language text sequence into a sequence of individual tokens.

In certain embodiments, the services invocation component 312 may include a software service suitable for programmatically calling or invoking, for example, the NLP service component 220 and the recommendation system and pipeline(s) 210. In one embodiment, a call to the recommendation system and pipeline(s) 210 comprises a JSON blob resulting from transforming a conversation using a recommendation pipeline JSON prompt. A property recommendation request directed to the recommendation system and pipeline(s) 210 can include main parameters such as intent (the user's recommendation intent that determines the retrieval strategy); user, platform (user and device identifiers); trip (characteristic of the trip like traveler type or booking window); property (property-related information, like filters to apply); and location—where should properties be retrieved from. TABLE 1 shows an example of a structured data request that could be used:

### TABLE 1—Structured Request to Recommendation System/Pipeline

{
   “use_case”: “genai_tripplanner_chat”,
   “intent”: {
      “rec_type”: “initial”,
      “strategies”: [
         “attractive”
      ],
      “themes”: [ ],
      },
      “user”: {
         “country_code”: “nl”,
         “language_code”: “en”,
         “currency_code”: “USD”
      },
      “platform”: {
         “site_type”: “iphone”,
         “user_os”: “14.4”,
         “user_version”: “28.4-iphone”
      },
      “trip”: {
         “guests”: {
         “total_adults”: 2
      },
      “rooms”: {
         “total”: 1
      },
      “booking_window”: {
         “checkin”: “2025-06-03”,
         “checkout”: “2025-06-05”
      },
      “property”: {
      “property_filters”: {
         “breakfast_included_filter”: {“has_breakfast_included”: true},
         }
      },
      “location”: {
         “location_type”: “city”,
         “location_cc1”: “nl”
      }
   },
}

In some embodiments, the services invocation component 312 may be further utilized to execute one or more calls to external services that may be associated with the user's request for a reservation of a travel itinerary, such as a current airline flight schedule, a current weather at a particular destination, local news reports associated with a particular destination, a local time zone associated with a particular destination, a current schedule of “pop-up” attractions associated with a particular destination or lodging, available ride-sharing services associated with a particular destination, available digital payment services associated with a particular destination or lodging, available food services and/or food options associated with a particular destination or lodging, and so forth. Examples of external services include external functions or vector databases.

### 2.4 Natural Language Processing (NLP) Service

FIG. 3B illustrates an example NLP service system 300B. As depicted, the NLP service system 300B may include an NLP service component 314. In one embodiment, the NLP service component 314 may be identical to the NLP service component 220, as discussed above with respect to FIG. 2. Thus, as generally discussed above, the NLP service component 314 may include machine-learning model-based service utilized for performing linguistic tasks, such as sentiment analysis, information retrieval, information extraction, text summarization, question-answering, tokenization, parts-of-speech tagging, parsing, and so forth that may be associated with providing contextual natural language responses to user input natural language text sequences provided to the application server 202, for example.

As depicted by FIG. 3B, in certain embodiments, the NLP service component 314 may include a manage dialogue component 316, a query/intent understanding component 318, a text moderation component 320, a generic NLP tasks component 322, and an embedding interface component 324. In certain embodiments, the manage dialogue component 316 may include a software service suitable for managing the conversational dialogue flows between the user and the LLM by leveraging, for example, one or more statistical models of the NLP service component 314 to exhibit broad world knowledge, linguistic competence, and conversational ability for increasing user experience.

In certain embodiments, the query/intent understanding component 318 may include, for example, a natural language understanding (NLU) service suitable for identifying and classifying intent and one or more named entities associated with the input natural language text sequence corresponding to a user's request for a reservation of a travel itinerary. For example, in certain embodiments, the query/intent understanding component 318 may identify and classify intent and one or more named entities associated with the input natural language text sequence corresponding to a user's request for a reservation of a travel itinerary by interpreting and understanding nuanced meanings, intentions, sentiments, semantics, and contexts embedded within user input natural language text sequences and deducing the user's specific purpose and objective by a given user input natural language text sequence.

In certain embodiments, the text moderation component 320 may include a software service suitable for flagging user-input natural language text sequences that do not correspond to a request for a reservation of a travel itinerary and/or expurgating user-input natural language text sequences that include obscene language, hate speech, or objectionable language. In various embodiments, text moderation component 320 can be programmed to submit a classification-moderation prompt to an LLM to filter out “dirty words.” Alternatively, text moderation component 320 can filter text using proprietary moderation ML models tuned for the travel domain and adhere to enterprise content guidelines. Examples of information that can be moderated or filtered out using appropriately trained models include but are not limited to Customer PII, abusive, racist, and discriminatory content, and content not compliant with brand and policy guidelines.

In certain embodiments, the generic NLP tasks component 322 may include, for example, an NLP service suitable for performing lesser complex NLP tasks, such as tokenization and parsing. In certain embodiments, the embedding interface component 324 may include a software service suitable for embedding a number of disparate interface functions into, for example, a singular interface function.

### 2.5 Recommendation System and Pipeline(s)

FIG. 4 illustrates an example recommendation system and pipeline(s) 400. As depicted, the recommendation system and pipeline(s) 400 may include a recommendation system and pipeline(s) 402. In one embodiment, the recommendation system and pipeline(s) 402 may be identical to the recommendation system and pipeline(s) 210 as discussed above with respect to FIG. 2. Thus, as generally discussed above, the recommendation system and pipeline(s) 402 may include one or more machine-learning model-based platforms suitable for surfacing and providing recommendations of one or more travel itineraries, such as travel destinations, accommodations, means of transport and so forth in a uniquely personalized manner and in accordance with an identified intent and one or more named entities associated with the input natural language text sequence corresponding to a user's request for a reservation of a travel itinerary.

As depicted by FIG. 4, in certain embodiments, the recommendation system and pipeline(s) 402 may include an AI recommendation resolver 404 and a prediction pipeline 406. In certain embodiments, as generally discussed above with respect to the generative AI reservation management and orchestration system 200 of FIG. 2, the recommendation system and pipeline(s) 402 may include a sequence of processes to be performed, for example, once the generative AI orchestrator 216 or generative AI orchestrator component 302 identifies an intent and one or more named entities associated with the input natural language text sequence corresponding to a user's request for a reservation of a travel itinerary. Specifically, in an embodiment, upon identifying an intent and one or more named entities associated with the input natural language text sequence corresponding to a user's request for a reservation of a travel itinerary, the generative AI orchestrator 216 or generative AI orchestrator component 302 may provide a request to the recommendation system and pipeline(s) 402 for recommendations of one or more travel itineraries and retrieve the recommendations of one or more travel itineraries from the recommendation system and pipeline(s) 402.

For example, as depicted by FIG. 4, the recommendation system and pipeline(s) 402 may receive user intent 408, trip features 410, and location or destination features 412. For example, user intent 408 could correspond to a search for a travel itinerary, and the trip features 410 could specify solo travel vs. group travel, leisure travel vs. business travel, time of travel, seasonality, and so forth, and the location or destination features 412 could specify destinations, lodgings, means of transport, attractions, and so forth.

In certain embodiments, the AI recommendation resolver 404 is programmed to apply one or more statistical models or machine-learning models, such as an entity resolver 414, a strategy resolver 416, and a feature resolver 418 to instantiate the prediction and decision-making for what type of recommendations of one or more travel itineraries should be surfaced or retrieved based on the identified intent and one or more named entities associated with the input natural language text sequence corresponding to the user's request for a reservation of a travel itinerary.

In certain embodiments, in response to the AI recommendation resolver 404 determining the type of recommendations of one or more travel itineraries to be surfaced or retrieved based on the user intent 408, the trip features 410, and the location or destination features 412, the AI recommendation resolver is programmed to provide the determination to the prediction pipeline 406. In certain embodiments, the prediction pipeline 406 may be utilized to generate predictions of recommendations of one or more travel itineraries to be provided, for example, to the generative AI orchestrator 216, and, ultimately, to the chat interface 214 of the reservation management application 212 executing on the mobile computing device 204 for display to a user, for example.

In certain embodiments, the prediction pipeline 406 may be associated with a recommendation pipeline registry 420. It may include a prediction graph 422A, one or more filters 424A, a data enrichment component 426A, one or more sorters 428A, and one or more selectors 430A. In certain embodiments, the prediction graph 422A may be utilized, for example, to select one or more machine-learning models 422B best suited for the type of recommendations of one or more travel itineraries to be surfaced or retrieved. For example, in one embodiment, the predictions of recommendations of one or more travel itineraries may be dependent on the complexity of the request, one or more predetermined system constraints, and the available information stored, for example, in the recommendation pipeline registry 420 and/or the one or more databases 106 at runtime. For example, the complexity of the request could involve domestic destinations vs. international destinations, domestic lodgings vs. international lodgings, weekend getaways vs. extended vacations, and so forth, and the system constraints could relate to execution time, load time, latency, and so forth.

In certain embodiments, one or more filters 424A may be utilized, for example, to filter the predictions of recommendations of one or more travel itineraries to only the most relevant predictions associated with the request and remove superfluous information 424B. Similarly, the data enrichment component 426A may be utilized to enrich the predictions of recommendations of one or more travel itineraries with a set of travel itinerary contextual information 426B, such as pricing information, visual image information, location or distance information, translation of content, user personal identity data, and so forth. In certain embodiments, one or more sorters 428A may be utilized, for example, to sort the predictions of recommendations of one or more travel itineraries according to the set of travel itinerary contextual information 426B, such as by distance, pricing, relevance, or other similar information 428B. Lastly, in certain embodiments, the one or more selectors 430A may be utilized to select from the predictions of recommendations of one or more travel itineraries the top K candidate recommendations of one or more travel itineraries that may be selected based on, for example, a generated matching score associated with each of the predictions of recommendations of one or more travel itineraries.

### 2.6 Trip Prediction System

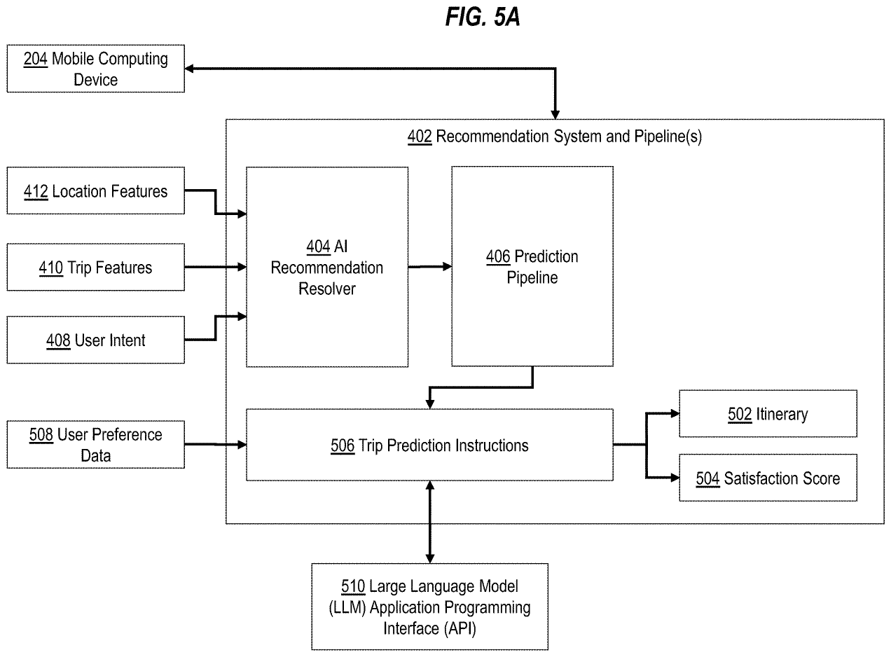

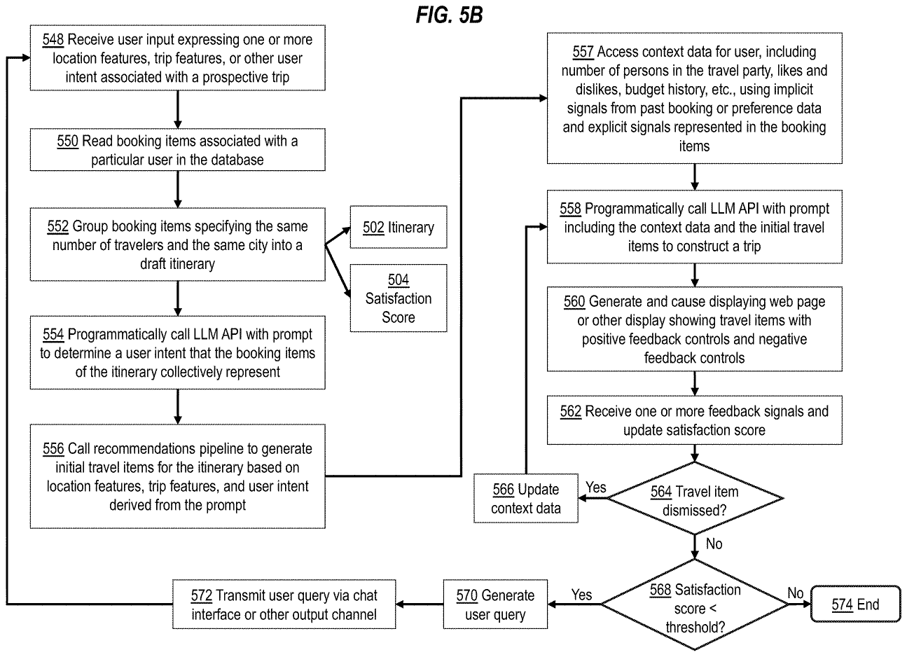

FIG. 5A illustrates a view of the system of FIG. 4 with additional trip prediction logic. As described above for FIG. 4, location features 412, trip features 410, and user intent 408 are received at the AI recommendation resolver 404, which is programmed to generate travel item recommendations and interoperate with prediction pipeline 406 to output recommended accommodations, properties, activities, and related travel items. In one embodiment, the recommendation system and pipeline 402 execute to create and store an itinerary 502 comprising a plurality of travel items or plans that correspond to the user intent expressed in an input, such as a chat conversation query or statement. In an embodiment, the recommendation system and pipeline 402 can be configured with trip prediction instructions 506 that are programmed to generate and track satisfaction score 504 for itinerary 502 and to suggest changes to the itinerary to increase the satisfaction score. The trip prediction instructions 506 can be programmed to receive user preference data 508 as further context to supplement recommendations from the prediction pipeline 406 and to prompt an application programming interface (API) or another endpoint of a large language model (LLM) to respond with the itinerary 502, updates to the itinerary, or other trip plans and data.

In an embodiment, when the orchestration system 200 determines that the user intent is to plan or construct a trip, control transfers to trip prediction instructions 506 of FIG. 5A. As previously described, the orchestration system 200 executes in response to receiving a user query from the chat interface. Based on the query, the orchestration system 200 determines whether the best action based on the user intent is to manage a dialog, moderate PII, classify an intent, generate a response, do a recommendation strategy, or take other actions. The input passes to a PII detection LLM and an intent detection LLM to yield user intent. The user intent maps to one of a plurality of different actions corresponding to the intent, e.g., a destination search, and the orchestration system 200 then acts upon data items in the query that are relevant to the intent. For example, for a destination search, the orchestration system 200 identifies the departure and arrival dates and destination name, provides the data to the recommendation system and pipeline 402, receives recommendations for the destination and dates, and requests an LLM to structure the recommendations into JSON format. A subsequent query can prompt the system to explain why the recommendations were given or request other recommendations. Responses corresponding to multiple recommendations and a trip can be formatted as a JSON object. The relevance of responses, overall, turns on how the user refines their prompts to express the correct intent. LLM prompts can comprise a master prompt template that includes branch sections that the LLM will use under specified conditions.

FIG. 5B illustrates an example processing flow that the trip prediction instructions are programmed to execute. In one embodiment, at block 550, the process of FIG. 5B is programmed to read booking items associated with a particular user in the database. For example, the trip prediction instructions 506 can be programmed to determine a user account identifier for a user who is then currently logged in and transmit a database query to retrieve all booking items in a booking database that are associated with the specified user account. In response to the query, a result set of booking items is received.

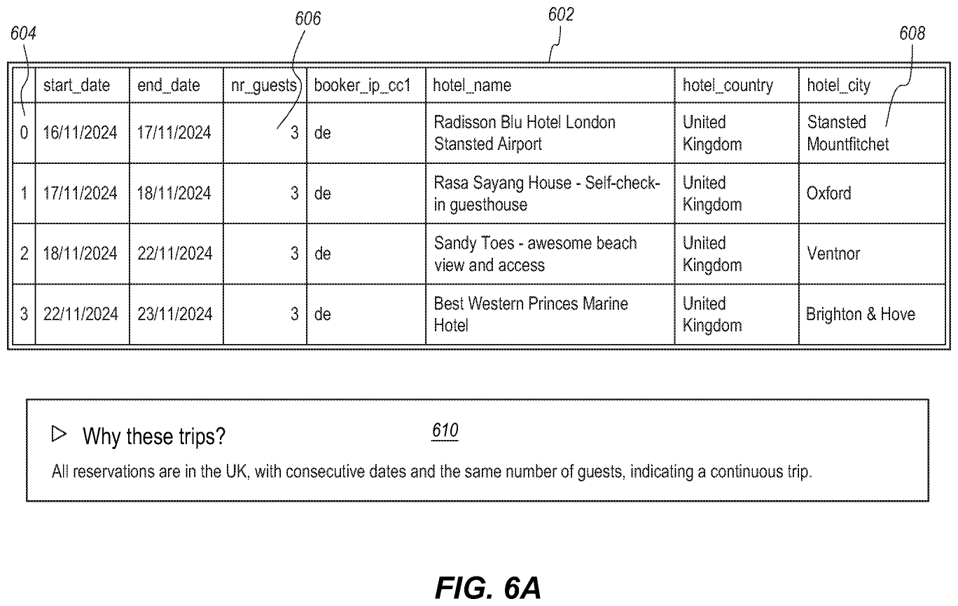

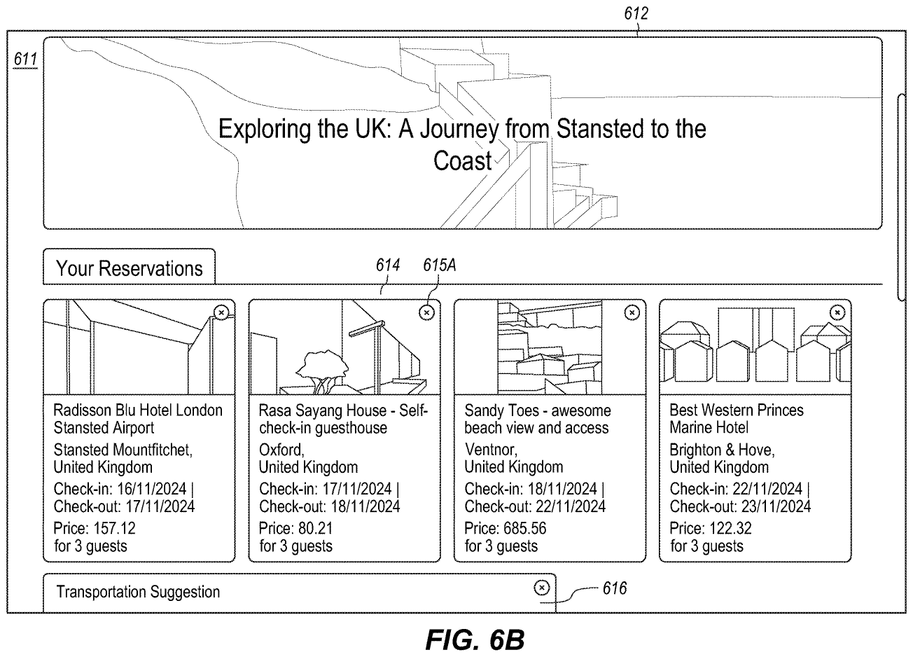

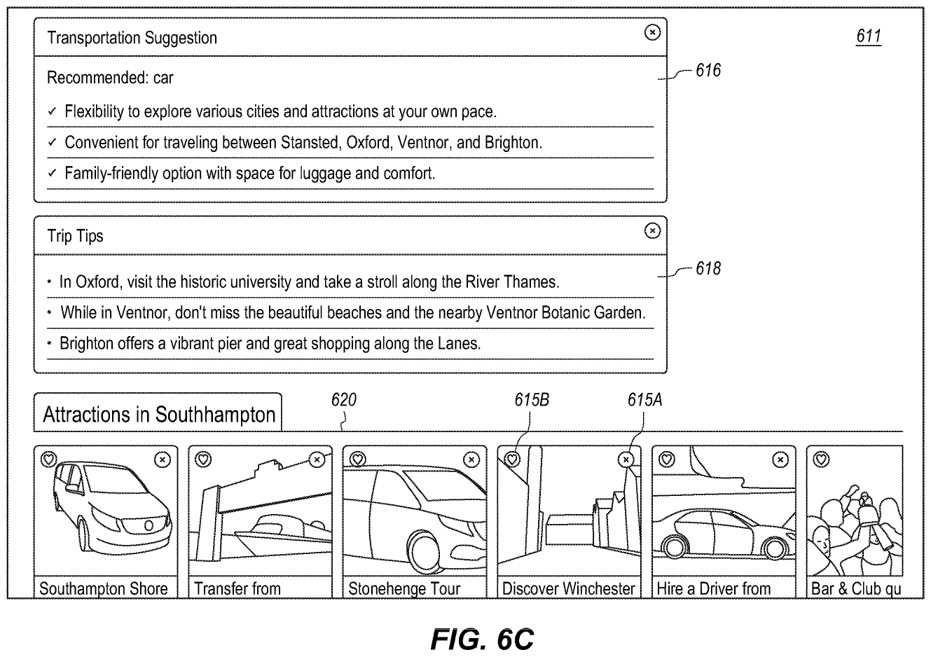

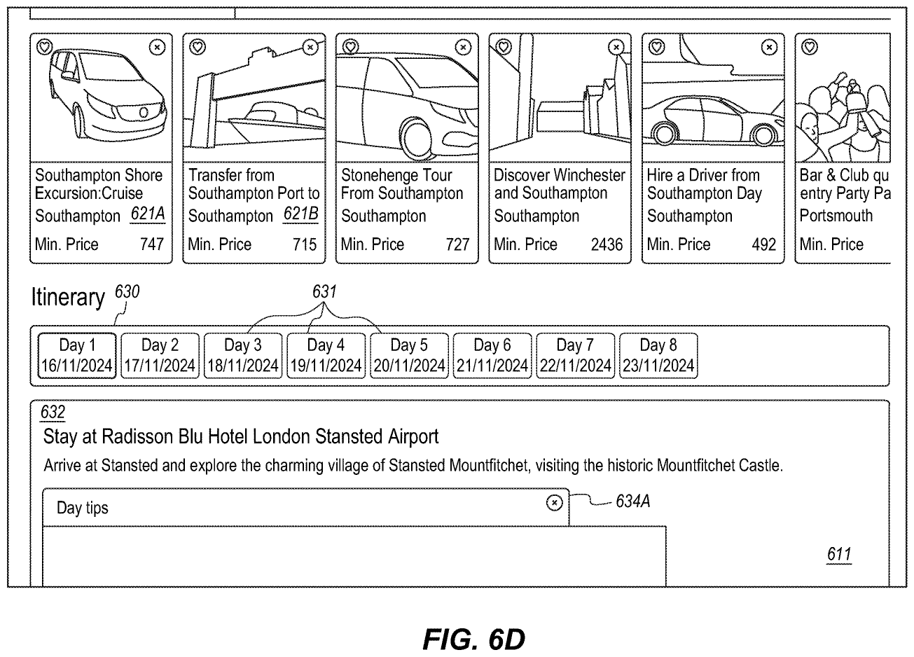

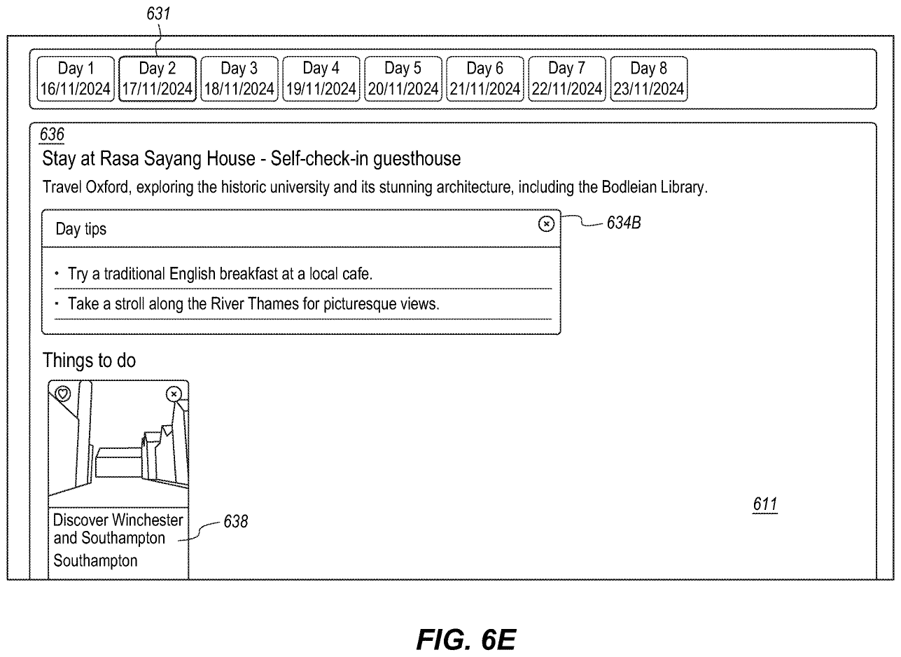

At block 552, the process of FIG. 5B is programmed to group the booking items specifying one or more common attributes, such as the same number of travelers and the same city, into a draft itinerary, such as itinerary 502 described previously. This yields an initial itinerary that can be enriched with other generated data of several kinds. The use of grouping will be apparent from the example user interface displays shown in FIG. 6A, FIG. 6B, FIG. 6C, FIG. 6D, and FIG. 6E, and described further in other sections below. In an embodiment, at block 554, the trip prediction instructions 506 are programmed to call the API of an LLM, which can be a public LLM API, an internally hosted LLM or a private instance of an LLM, with a prompt to determine a user intent that the booking items of the itinerary collectively represent. The user intent derived from the grouped booking items serves as an anchor point for later LLM prompts to generate text for tips, suggestions, and recommendations of transportation, activities, attractions, and similar data to enrich and enhance the itinerary and thereby increase satisfaction.

At block 556, the process is programmed to call the recommendations pipeline to generate initial travel items for the itinerary based on location features, trip features, and user intent derived from the prompt.

At block 557, the process is programmed to access context data for the user, including but not limited to items such as the number of persons in the travel party, likes and dislikes, budget history, etc., using implicit signals from past booking or preference data and explicit signals represented in the booking items.

At block 558, the process is programmed to programmatically call the LLM API 510 with a prompt including the context data and the initial travel items to construct a trip. In response, an LLM accessible via the LLM API 510 returns a response identifying a trip according to a specified format. For example, the prompt can instruct the LLM to return a description of a trip in JSON or XML format.

At block 560, the process is programmed to generate and cause displaying a web page or other display showing travel items with positive feedback controls and negative feedback controls. Examples of web pages that can be used in various embodiments are shown in FIG. 6A, FIG. 6B, FIG. 6C, FIG. 6D, and FIG. 6E, and described further in other sections below.

At block 562, the process is programmed to receive one or more feedback signals and update the satisfaction score. For example, at block 564, the process is programmed to receive a feedback signal specified that the user dismissed a particular travel item dismissed. In response, at block 566, the process is programmed to update the context data to mark the specified travel item as undesired. If no feedback signal is received, at block 568, the process is programmed to test whether the satisfaction score is less than a threshold value, which can be stored in configuration data, user settings, or other storage.

If the test of block 568 is YES, TRUE, or a functional equivalent, then at block 570 the process is programmed to generate a query to the user and at block 572 to transmit the user query via a chat interface or other output channel. The content of the user query can prompt the user to provide more information about the user intent or to specify why the particular travel item was dismissed. Control continues back at block 548 in which user input in response to the query of block 570-572 is used in the same manner as previously described for block 548 and subsequent blocks. In this manner, feedback signals received at block 564 form a feedback loop to refine the user intent and cause generating an updated travel plan.

Otherwise, if the satisfaction score is greater than the threshold value as tested at block 568, control transfers to block 574 at which the process is programmed to return control to another process or otherwise discontinue generating a travel plan. However, the process of FIG. 5B can execute any number of times, asynchronously, in response to specified user input or GUI controls, or otherwise as needed or appropriate.

FIG. 6A illustrates a set of example travel booking items. In an embodiment, a set of records 602 comprises a plurality of rows 604, each representing a travel booking item having column values for a start date, end date, number of guests, country code of booking person, hotel name, hotel country, and hotel city. The rows 604 and columns of FIG. 6A can represent a partial view of a table in a database for travel bookings associated with a particular user account. It will be apparent that all the values for a number of guests are the same, and all the values for the hotel country are the same. Therefore, in an embodiment, under the process of FIG. 5B, the trip prediction instructions 506 are programmed to associate all rows 604 with the itinerary 502. Further, the effect of block 554 is to determine that the intent of the user is to stay at the accommodations specified in the table within a specified time window; in some cases, the LLM prompt can include instructions to undertake web searching or other fact investigations to identify other possible user intent. For example, searches might reveal that a conference is scheduled at the specified location within the time window, so the user intent could be to attend the conference.

Referring again to FIG. 5B, at block 556, the trip prediction instructions 506 are programmed to access context data for the user, including the number of persons in the travel party, likes and dislikes, budget history, etc., using implicit signals from past booking or preference data and explicit signals represented in the booking items. Implicit signals also could include search history, such as the user undertaking a budget-constrained search for accommodations; booking history, such as multiple past bookings for two persons, indicating a preference for travel with a party of two; or an explicit comment that the user dislikes a particular attraction like museums. Accepting or dismissing suggestions can constitute implicit signals relative to budget or other preferences. Preference data of this kind is collected in one or more databases and/or temporarily stored in memory. In some embodiments, preference data is obtained from a customer data platform (CDP) that tracks user interactions with email, social media, and browsers to determine how user journeys transition from different media to a travel search system. Preference data also can be stored in a user needs database that stores, for users with persistent accounts in the system, specific definitions of needs or preferences such as accessible accommodations, swimming pool, pet accommodations, etc. The preference data can be augmented with inventory information specifying available accommodations and included in a prompt or query to an LLM. The data in the prompt or query, combined with the world knowledge that an LLM has been trained on, enables generating a response specifying a trip. Constructing a trip also can use RAG techniques or fine-tuned models.

FIG. 6A illustrates a set of example travel booking items and has been described above. FIG. 6B, FIG. 6C, FIG. 6D and FIG. 6E illustrate examples of graphical user interfaces displaying portions of an itinerary. In one embodiment, FIG. 6B, FIG. 6C, FIG. 6D, and FIG. 6E collectively represent the first through fourth portions of a single electronic document or web page.

FIG. 6B illustrates a scrollable portion of an example web page. In an embodiment, a web page 611 comprises a title bar 612 displaying a descriptive title, which can be generated by submitting text elements of rows 604 in a query or prompt to an LLM and asking the LLM to respond with a short title and describes a trip involving the rows. In an embodiment, the web page 611 further comprises a reservations panel 614 that visually presents the travel items represented in the rows 604, which price data and images obtained via queries to websites associated with the properties described in the rows. In an embodiment, the web page 611 further comprises a transportation suggestion panel 616, bridging FIG. 6B and FIG. 6C, containing a suggested mode of transportation between the items represented in the row 604, with a list of reasons why the suggestion was made. The data shown in the transportation suggestion panel 616 can be generated by the trip prediction instructions 506 programmatically transmitting a prompt to the LLM specifying the travel items represented in rows 604, asking the LLM API 510 to determine the best mode of transportation, and asking the LLM to give the reasons why the transportation mode was suggested. In all such embodiments, rather than a public LLM API in the form of LLM API 510, a fine-tuned hosted machine-learning model or fine-tuned public LLM like Llama can be used.

Embodiments can calculate and use a satisfaction score, which measures the degree of user or customer satisfaction with an itinerary or trip. In one embodiment, a customer or user booking a trip after the trip has been constructed and presented to the user causes creating and storing a satisfaction score having a maximum magnitude and storing the satisfaction score in association with the trip. Another embodiment can be programmed to display a prompt to the user in the user interface in which the trip is presented that asks the user to respond whether the trip is satisfactory. Another embodiment can be programmed to display a feedback link in association with a trip or elements of a trip that is programmed as an active link and, when selected, causes the posting of a feedback signal to the system. For example, reservations panel 614 comprises an “X” link 615A, which, when selected, dismisses the reservations panel from the trip and posts a negative feedback message to the server. As another example, as seen in FIG. 6C, a panel can comprise both an “X” link 615A and a “heart” link 615B. When the “heart” link 615B is selected, a positive feedback message is posted to the server and the panel can be redisplayed with the “heart” icon filled, colored, or highlighted. In any of these embodiments, select the “X” link 615A can also signal the server to regenerate a new panel for a new recommendation to substitute for the dismissed recommendation.

Referring to FIG. 6C, in an embodiment, web page 611 further comprises a tips panel 618 comprising text specifying a short set of suggestions for activities during the itinerary. In an embodiment, the data shown in the tips panel 618 can be generated by the trip prediction instructions 506 programmatically transmitting a prompt to the LLM specifying the travel items represented in rows 604 and asking the LLM to specify a short set of sights, activities, or attractions in one or more of the places specified in the rows.

In an embodiment, bridging FIG. 6C and FIG. 6D, the web page 611 further comprises an attractions panel 620 comprising a plurality of thumbnail images of locations near one of the destinations of the itinerary. Each of the thumbnail images 621A and 621B can include a name or title, description, and/or price data. In an embodiment, the data shown in the attractions panel 620 can be generated by the trip prediction instructions 506 programmatically transmitting a prompt to the LLM specifying one or the destinations of one of the rows 604 and asking the LLM to specify a short set of attractions near that destination, with information about how to format a response.

Referring again to FIG. 6D, in an embodiment, the web page 611 further comprises an itinerary panel 630 comprising a plurality of day widgets 631, each corresponding to a different day of the itinerary. The example of FIG. 6D shows an 8-day itinerary with eight (8) day widgets 631 respectively associated with different days between 16-23 Nov. 2024, although this data is an arbitrary example. Each day widget 631 is programmed as an active link, which, when selected, causes displaying a day panel 632 that describes specific plans for the day represented in the day widget. For example, FIG. 6D shows a day panel 632 describing a hotel stay with a tips panel 634A for activity tips specific to that day and location. The example of FIG. 6E represents a display in which the day widget 631 for “17/11/2024” has been selected; in response, the trip prediction instructions 506 are programmed to generate a different day panel 636 corresponding to the accommodation in the itinerary for that day, with a different tip panel 634B specifying travel tips associated with the second location. Each trips panel can include one or more activity panels 638 each comprising a visual image, description, location, and information about an activity.

In an embodiment, all data shown in FIG. 6D, FIG. 6E can be generated by the trip prediction instructions 506 programmatically transmitting a prompt to the LLM specifying the travel items represented in rows 604 and asking the LLM to specify a short set of sights, activities, or attractions in one or more of the places specified in the rows with formatting information to divide responsive text and image links into sets that can form a basis of visually rendering the panels shown in the drawing figures using a browser.

### 6. Implementation Example—Hardware Overview

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

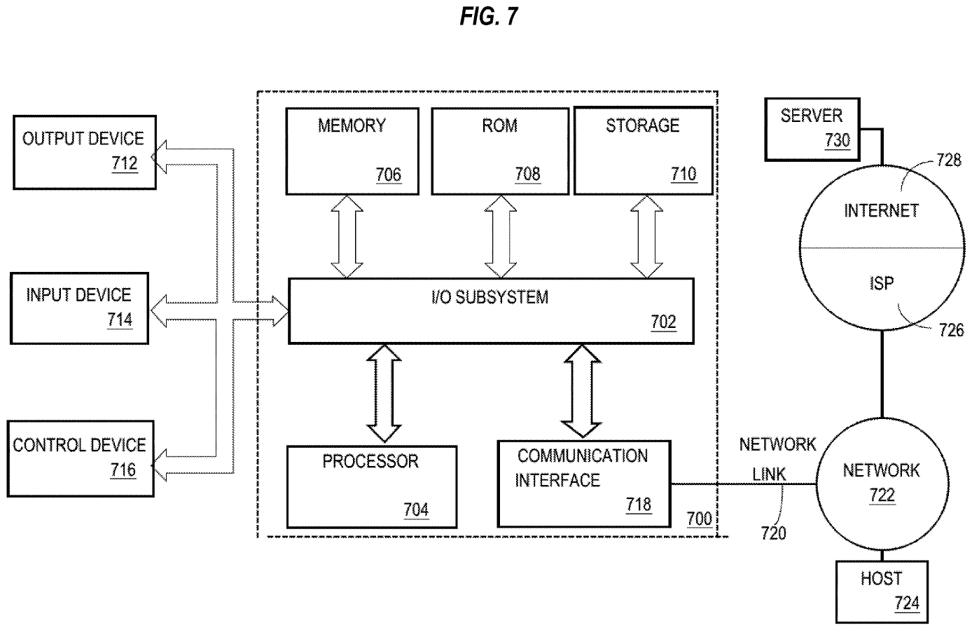

FIG. 7 is a block diagram that illustrates an example computer system with which an embodiment may be implemented. In the example of FIG. 7, a computer system 700 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 700 includes an input/output (I/O) subsystem 702 which may include a bus and/or other communication mechanism(s) for communicating information and/or instructions between the components of the computer system 700 over electronic signal paths. The I/O subsystem 702 may include an I/O controller, a memory controller and at least one I/O port. The electronic signal paths are represented schematically in the drawings, for example as lines, unidirectional arrows, or bidirectional arrows.

At least one hardware processor 704 is coupled to I/O subsystem 702 for processing information and instructions. Hardware processor 704 may include, for example, a general-purpose microprocessor or microcontroller and/or a special-purpose microprocessor such as an embedded system or a graphics processing unit (GPU) or a digital signal processor or ARM processor. Processor 704 may comprise an integrated arithmetic logic unit (ALU) or may be coupled to a separate ALU.

Computer system 700 includes one or more units of memory 706, such as a main memory, which is coupled to I/O subsystem 702 for electronically digitally storing data and instructions to be executed by processor 704. Memory 706 may include volatile memory such as various forms of random-access memory (RAM) or other dynamic storage device. Memory 706 also may be used for storing temporary variables or other intermediate information during execution of instructions to be executed by processor 704. Such instructions, when stored in non-transitory computer-readable storage media accessible to processor 704, can render computer system 700 into a special-purpose machine that is customized to perform the operations specified in the instructions.

Computer system 700 further includes non-volatile memory such as read only memory (ROM) 708 or other static storage device coupled to I/O subsystem 702 for storing information and instructions for processor 704. The ROM 708 may include various forms of programmable ROM (PROM) such as erasable PROM (EPROM) or electrically erasable PROM (EEPROM). A unit of persistent storage 710 may include various forms of non-volatile RAM (NVRAM), such as FLASH memory, or solid-state storage, magnetic disk or optical disk such as CD-ROM or DVD-ROM and may be coupled to I/O subsystem 702 for storing information and instructions. Storage 710 is an example of a non-transitory computer-readable medium that may be used to store instructions and data which when executed by the processor 704 cause performing computer-implemented methods to execute the techniques herein.

The instructions in memory 706, ROM 708 or storage 710 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 700 may be coupled via I/O subsystem 702 to at least one output device 712. In one embodiment, output device 712 is a digital computer display. Examples of a display that may be used in various embodiments include a touch screen display or a light-emitting diode (LED) display or a liquid crystal display (LCD) or an e-paper display. Computer system 700 may include other type(s) of output devices 712, alternatively or in addition to a display device. Examples of other output devices 712 include printers, ticket printers, plotters, projectors, sound cards or video cards, speakers, buzzers or piezoelectric devices or other audible devices, lamps or LED or LCD indicators, haptic devices, actuators or servos.

At least one input device 714 is coupled to I/O subsystem 702 for communicating signals, data, command selections or gestures to processor 704. Examples of input devices 714 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 716, which may perform cursor control or other automated control functions such as navigation in a graphical interface on a display screen, alternatively or in addition to input functions. Control device 716 may be a touchpad, a mouse, a trackball, or cursor direction keys for communicating direction information and command selections to processor 704 and for controlling cursor movement on an output device 712 such as a display. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 714 may include a combination of multiple different input devices, such as a video camera and a depth sensor.

In another embodiment, computer system 700 may comprise an internet of things (IoT) device in which one or more of the output device 712, input device 714, and control device 716 are omitted. Or, in such an embodiment, the input device 714 may comprise one or more cameras, motion detectors, thermometers, microphones, seismic detectors, other sensors or detectors, measurement devices or encoders and the output device 712 may comprise a special-purpose display such as a single-line LED or LCD display, one or more indicators, a display panel, a meter, a valve, a solenoid, an actuator or a servo.

When computer system 700 is a mobile computing device, input device 714 may comprise a global positioning system (GPS) receiver coupled to a GPS module that is capable of triangulating to a plurality of GPS satellites, determining and generating geo-location or position data such as latitude-longitude values for a geophysical location of the computer system 700. Output device 712 may include hardware, software, firmware and interfaces for generating position reporting packets, notifications, pulse or heartbeat signals, or other recurring data transmissions that specify a position of the computer system 700, alone or in combination with other application-specific data, directed toward host computer 724 or server computer 730.

Computer system 700 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 700 in response to processor 704 executing at least one sequence of at least one instruction contained in main memory 706. Such instructions may be read into main memory 706 from another storage medium, such as storage 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 710. Volatile media includes dynamic memory, such as memory 706. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 702. Transmission media can also take the form of acoustic or light waves, such as those generated during radio-wave and infra-red data communications.

Various forms of media may be involved in carrying at least one sequence of at least one instruction to processor 704 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 700 can receive the data on the communication link and convert the data to a format that can be read by computer system 700. For instance, a receiver such as a radio frequency antenna or an infrared detector can receive the data carried in a wireless or optical signal and appropriate circuitry can provide the data to I/O subsystem 702 such as place the data on a bus. I/O subsystem 702 carries the data to memory 706, from which processor 704 retrieves and executes the instructions. The instructions received by memory 706 may optionally be stored on storage 710 either before or after execution by processor 704.

Computer system 700 also includes a communication interface 718 coupled to I/O system 702 in the manner of a bus. Communication interface 718 provides a two-way data communication coupling to network link(s) 720 that are directly or indirectly connected to at least one communication networks, such as a network 722 or a public or private cloud on the Internet. For example, communication interface 718 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 722 broadly represents a local area network (LAN), wide-area network (WAN), campus network, internetwork or any combination thereof. Communication interface 718 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 718 sends and receives electrical, electromagnetic or optical signals over signal paths that carry digital data streams representing various types of information.

Network link 720 typically provides electrical, electromagnetic, or optical data communication directly or through at least one network to other data devices, using, for example, satellite, cellular, Wi-Fi, or BLUETOOTH technology. For example, network link 720 may provide a connection through a network 722 to a host computer 724.

Furthermore, network link 720 may provide a connection through network 722 or to other computing devices via internetworking devices and/or computers that are operated by an Internet Service Provider (ISP) 726. ISP 726 provides data communication services through a world-wide packet data communication network represented as internet 728. A server computer 730 may be coupled to internet 728. Server computer 730 broadly represents any computer, data center, virtual machine or virtual computing instance with or without a hypervisor, or computer executing a containerized program system such as DOCKER or KUBERNETES. Server computer 730 may represent an electronic digital service that is implemented using more than one computer or instance and that is accessed and used by transmitting web services requests, uniform resource locator (URL) strings with parameters in HTTP payloads, API calls, app services calls, or other service calls. Computer system 700 and server computer 730 may form elements of a distributed computing system that includes other computers, a processing cluster, server farm or other organization of computers that cooperate to perform tasks or execute applications or services. Server computer 730 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server computer 730 may comprise a web application server that hosts a presentation layer, application layer and data storage layer such as a relational database system using structured query language (SQL) or no SQL, an object store, a graph database, a flat file system or other data storage.

Computer system 700 can send messages and receive data and instructions, including program code, through the network(s), network link 720 and communication interface 718. In the Internet example, a server computer 730 might transmit a requested code for an application program through Internet 728, ISP 726, local network 722 and communication interface 718. The received code may be executed by processor 704 as it is received, and/or stored in storage 710, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 704. While each processor 704 or core of the processor executes a single task at a time, computer system 700 may be programmed to implement multitasking to allow each processor to switch between tasks that are being executed without having to wait for each task to finish. In an embodiment, switches may be performed when tasks perform input/output operations when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

### 4. Benefits, Improvements, and Alternatives

Embodiments offer several technical benefits and improvements compared to past practice. Information about existing booking items, such as reservations for flights, accommodations, or attractions, are combined in an engineered LLM prompt with other user input specifying location features, trip features, or other user intent associated with a prospective trip, and transmitted to an LLM API to output user intent data. This approach results in far more accurate user intent data because user-created booking items help bias the LLM response while still allowing consideration of location features, trip features, or other data expressed in a user query in a softer manner. The user intent data forms the basis of a call to a recommendations pipeline to output highly accurate available accommodations and attractions data for presentation in a trip plan. Unlike prior approaches offering less accurate recommendations based only on soft user intent data such as “show me beach properties in Aruba,” the LLM-based refinement of user intent based on existing booking items results in far more accurate output. When output is more accurate, CPU cycles and network bandwidth are reduced because the system does not generate and present to the user computing device trip plans that are inaccurate and likely to be rejected by the user. The resulting trip plan can be presented in detail in an extensive user interface or web page with positive and negative feedback controls used in a feedback loop to improve subsequent iterations of generating user intent data and recommendations.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method comprising:
reading travel booking items associated with a particular user account in a database;
grouping the travel booking items specifying one or more common attributes into a digitally stored draft travel itinerary;
programmatically calling a large language model (LLM) application programming interface (API) with a first prompt to determine a user intent that the travel booking items of the draft travel itinerary collectively represent and receiving a first LLM response specifying the user intent;
calling a recommendations pipeline to generate initial additional travel items for the draft travel itinerary based on location features, trip features, and the user intent of the first LLM response;
accessing context data for the particular user account and one or more implicit signals from past booking or preference data and explicit signals represented in the booking items;
receiving user input expressing one or more location features or trip features associated with a prospective trip;
programmatically calling the LLM API with a second prompt, including the context data and the initial additional travel items, receiving a second LLM response, and forming a digitally stored updated travel itinerary;
generating and causing displaying a digital electronic document showing travel items of the second LLM response with positive feedback controls and negative feedback controls;
receiving one or more feedback signals via the positive feedback controls or the negative feedback controls; and, in response, updating a satisfaction score associated with the particular user account and the updated travel itinerary;
updating the context data in response to determining a travel item is dismissed based on the one or more feedback signals;
generating a user query in response to determining the satisfaction score is below a threshold value; and
transmitting the user query via a chat interface.

2. The method of claim 1, wherein the reading of travel booking items associated with a particular user in the database further comprises accessing two or more relational database tables storing historical booking data and user preferences.

3. The method of claim 1, wherein the grouping of the travel booking items into a draft travel itinerary further comprises identifying travel booking items that share common attributes including one or more of travel dates, destinations, or number of travelers.

4. The method of claim 1, wherein the programmatically calling of the LLM API with the first prompt comprises generating a natural language prompt that encapsulates the travel booking items and the context data.

5. The method of claim 1, further comprising receiving, from the recommendations pipeline, the initial additional travel items in response to the recommendations pipeline programmatically analyzing one or more of points of interest, local events, or weather conditions.

6. The method of claim 1, wherein the context data accessed includes user preferences derived from social media activity, previous travel reviews, and interaction history with a travel service provider.

7. The method of claim 1, wherein the user input received includes specific preferences for accommodation types, transportation modes, and activity interests.

8. The method of claim 1, wherein the digital electronic document comprises one or more user interface widgets which, when selected, modify or approve one or more travel items of the updated travel itinerary.

9. The method of claim 1, wherein the one or more feedback signals received include user interactions including one or more of clicks, likes, dislikes, or comments on one or more travel items.

10. The method of claim 1, further comprising calculating the satisfaction score based on a weighted combination of the positive and negative feedback signals.

11. The method of claim 1, wherein the user query includes suggestions for alternative travel items or requests for additional information based on the one or more feedback signals.

12. The method of claim 1, wherein the chat interface supports natural language processing to facilitate user interaction and response.

13. A system for generating travel itinerary recommendations, the system comprising:
a reservation management system configured to read booking items associated with a user;
a large language model (LLM) application programming interface (API) configured to determine user intent based on the booking items;
a recommendations pipeline configured to generate initial travel items based on location features, trip features, and the user intent;
a context data module configured to access user context data including travel party size, preferences, and budget history;
a user input module configured to receive user input expressing location features or trip features;
a display module configured to generate and display travel items with feedback controls;
a feedback module configured to receive feedback signals and update a satisfaction score;
a query generation module configured to generate user queries in response to determining the satisfaction score is below a threshold; and
a communication interface configured to transmit the user queries via a chat interface.

14. The system of claim 13, wherein the reservation management system is further configured to access a database storing historical booking data and user preferences.

15. The system of claim 13, wherein the LLM API is configured to generate natural language prompts that encapsulate the booking items and the user context data.

16. The system of claim 13, wherein the recommendations pipeline analyzes location features including one or more of points of interest, local events, or weather conditions to generate initial travel items.

17. The system of claim 13, wherein the context data module accesses user preferences derived from social media activity, previous travel reviews, and interaction history with a travel service provider.

18. The system of claim 13, wherein the user input module receives specific preferences for accommodation types, transportation modes, and activity interests.

19. The system of claim 13, wherein the display module provides one or more user interface widgets which, when selected, modify or approve suggested travel items.

20. The system of claim 13, wherein the feedback module calculates the satisfaction score based on a weighted combination of positive and negative feedback signals.
